(19) United States
(12) Patent Application Publication
(10) Pub. No.: US 2011/0026757 A1
(43) Pub. Date: Feb. 3, 2011

(54) ACOUSTIC CONVERTER DIAPHRAGM, AND ACOUSTIC CONVERTER

(75) Inventors: Hideki Takahashi, Yamagata (JP); Hayato Otomo, Yamagata (JP); Kenji Takahashi, Yamagata (JP)

Correspondence Address: OSHA LIANG L.L.P., TWO HOUSTON CENTER, 909 FANNIN, SUITE 3500, HOUSTON, TX, 77010, US

(73) Assignees: PIONEER CORPORATION, Tokyo (JP); TOHOKU PIONEER CORPORATION, Yamagata (JP)

(21) Appl. No.: 12/920,829

(22) PCT Filed: Oct. 31, 2008
(86) PCT No.: PCT/JP2008/069946

§ 371 Date: Oct. 20, 2010

(30) Foreign Application Priority Data
Mar. 28, 2008 (JP) PCT/JP2008/056112

(51) Int. Cl. H04R 9/06; H04R 7/02

(52) U.S. Cl. 381/397; 381/412; 181/166

(57) ABSTRACT

A diaphragm for acoustic converter includes a base and a damping layer formed on one surface or both surfaces of the base. The damping layer includes a particle having a heat dissipating function, and has detachability with respect to the base.

### FIELD OF TECHNOLOGY

The present invention relates to a diaphragm for an acoustic converter and an acoustic converter.

### BACKGROUND OF THE INVENTION

There is known a small size diaphragm for a speaker used for a small size device such as a mobile phone (for example, see patent literature 1). A diaphragm that is produced by heating and press forming for example a sheet made of polyethylene, etc., is known as a small size diaphragm. Further, a diaphragm that is formed by providing an elastomer layer on one side or both sides of a resin base is known (for example, see patent literature 1).

[Patent literature 1] Publication of Unexamined Patent Application 2004-312085

### SUMMARY OF THE INVENTION

Generally, when an acoustic converter such as a small size speaker device is driven for a long time, the temperature of the diaphragm itself may be increased, causing the properties of the diaphragm (storage elastic modulus, loss tangent, etc.) to change, and thereby the acoustic quality may be deteriorated.

Therefore, a diaphragm for acoustic converter that has a comparatively high thermolytic action is desired.

By the way, a diaphragm provided with a rib to restrain the occurrence of divided vibrations (divided resonance included) is known as a diaphragm for acoustic converter that is used for a mobile phone, etc. Generally, the rib is press formed by a die. However, if the adhesion between the diaphragm and the die is comparatively strong, the formability of the rib may be deteriorated (repeatability may be decreased), and thereby dispersion in performance of restraining the divided vibrations, etc. may occur between a plurality of diaphragms.

As such, a diaphragm that has a comparatively high releasing property between a diaphragm and a die is desired.

By the way, conflicting properties such as a comparatively small lowest resonance frequency (F0), a comparatively great loss tangent (tan δ) and a comparatively small diaphragm weight, etc. are required as the properties of a diaphragm.

Specifically, when simply making a diaphragm with a general diaphragm material, it is required to make the diaphragm by using a diaphragm material that has a comparatively small storage elastic modulus in order to make a lowest resonance frequency of the diaphragm comparatively small. As such, it is difficult to meet the requirements as described above.

Therefore, a diaphragm that has a comparatively small lowest resonance frequency (F0) as well as a comparatively great loss tangent (tan δ) is desired. Further, a comparatively light weight diaphragm that has these properties is desired.

The present invention is intended to address these problems. In other words, objects of the present invention are to provide a diaphragm for acoustic converter that has a comparatively high thermolytic action, to provide a diaphragm for acoustic converter that has a comparatively high releasing property, to provide a diaphragm for acoustic converter that has a comparatively small lowest resonance frequency (F0) and a comparatively great loss tangent (tan δ), and to provide an acoustic converter that includes the above-mentioned diaphragm for acoustic converter, etc.

To achieve these objects, the present invention is provided with at least the following aspects.

The diaphragm for acoustic converter according to one aspect of the present invention is a diaphragm for acoustic converter that includes a base and a damping layer that is formed on one surface or both surfaces of the base. Specifically, the damping layer includes a particle having a heat dissipating function, and the damping layer has detachability with respect to the base.

According to one aspect, the diaphragm for acoustic converter preferably has a smaller storage elastic modulus than the storage elastic modulus of the base of the diaphragm for acoustic converter.

Further, according to one aspect, the diaphragm for acoustic converter preferably has a greater loss tangent than the loss tangent of the base of the diaphragm for acoustic converter.

An acoustic converter according to one aspect of the present invention includes a vibrating body that has the diaphragm for acoustic converter and a voice coil supported by the diaphragm for acoustic converter, a frame that vibratably supports the vibrating body, and a magnetic circuit that forms a magnetic gap in which the voice coil is arranged.

### BRIEF DESCRIPTION OF THE DRAWINGS

FIG. 1 is a view that illustrates an acoustic converter (speaker device) employing a diaphragm for acoustic converter according to an embodiment of the present invention. Specifically, FIG. 1(A) is a front view of the acoustic converter (speaker device) and FIG. 1(B) is a cross-sectional view of the acoustic converter (speaker device) shown in FIG. 1(A).

FIG. 2(A) is an enlarged cross-sectional view of the diaphragm for acoustic converter according to a first embodiment of the present invention, FIG. 2(B) is an enlarged cross-sectional view of the diaphragm for acoustic converter according to a second embodiment of the present invention, FIG. 2(C) is an enlarged cross-sectional view of the diaphragm for acoustic converter according to a third embodiment of the present invention and FIG. 2(D) is an enlarged cross-sectional view of the diaphragm for acoustic converter according to a fourth embodiment of the present invention.

FIG. 3(A) is a view that illustrates a method of manufacturing the diaphragm for acoustic converter shown in FIG. 2(A) according to an embodiment, and FIG. 3(B) is a cross-sectional view of the diaphragm for acoustic converter made by die pressing shown in FIG. 3(A).

FIG. 4(A) is a view that illustrates a measuring instrument 50 and a diaphragm 1, and FIG. 4(B) is a view that illustrates the whole measuring instrument 50.

FIG. 5(A) is a view that illustrates a frequency characteristic of the vibration acceleration of a diaphragm measured by the measuring instrument 50, and FIG. 5(B) is a view that illustrates a method of measuring Young's modulus (E′) and internal loss (tan δ).

FIG. 6(A) is a view that illustrates a temperature characteristic of the internal loss (loss tangent (tan δ)) of PPSU. FIG. 6(B) is a view that illustrates temperature characteristics of the internal loss (loss tangent (tan δ)) of Hybler (HYB).

FIG. 7(A) is a view that illustrates a frequency characteristic of Young's modulus (storage elastic modulus (E′)) of PEN, FIG. 7(B) is a view that illustrates frequency characteristics of the internal loss (loss tangent (tan δ)) of PEN, FIG. 7(C) is a view that illustrates frequency characteristics of Young's modulus (storage elastic modulus (E′)) of PEI, and FIG. 7(D) is a view that illustrates frequency characteristics of the internal loss (loss tangent (tan δ)) of PEI.

FIG. 8(A) is a view that illustrates frequency characteristics of Young's modulus (storage elastic modulus) of PPSU, FIG. 8(B) is a view that illustrates frequency characteristics of the internal loss (loss tangent) of PPSU, FIG. 8(C) is a view that illustrates frequency characteristics of Young's modulus (storage elastic modulus) of a diaphragm that has a base and a damping layer, FIG. 8(D) is a view that illustrates frequency characteristics of the internal loss (loss tangent) of a diaphragm that has a base and a damping layer, FIG. 8(E) is a view that illustrates frequency characteristics of Young's modulus (storage elastic modulus) of a diaphragm that has a base (PA) and a damping layer PB including a heat dissipating particle (PC), and FIG. 8(F) is a view that illustrates frequency characteristics of the internal loss (loss tangent) of a diaphragm that has the base (PA) and the damping layer (PB) containing the heat dissipating particles (PC).

FIG. 9(A) is a view that illustrates sound pressure frequency characteristics of a diaphragm that has the base (PA) and the damping layer (PB), and FIG. 9(B) is a view that illustrates a sound pressure frequency characteristic of a diaphragm that has the base (PA) and the damping layer (PB) including the heat dissipating particles (PC).

FIG. 10 is a view that shows temperature dependence of the internal loss in the diaphragm for acoustic converter according to an embodiment of the present invention. Specifically, FIG. 10(A) shows a first embodiment and FIG. 10(B) shows a second embodiment.

FIG. 11 is a view that illustrates temperature dependence of the internal loss and storage elastic modulus in the diaphragm for acoustic converter according to an embodiment of the present invention. In FIG. 11(A), the vertical axis represents internal loss (loss tangent (tan δ)) and the horizontal axis represents temperature (T: unit ° C.). In FIG. 11(B), the vertical axis represents Young's modulus (storage elastic modulus (E′)) and the horizontal axis represents temperature (T: unit ° C.).

FIG. 12 is a view that illustrates electronic devices provided with an acoustic converter according to an embodiment of the present invention. Specifically, FIG. 12 (A) shows a handheld terminal and FIG. 12(B) shows a flat panel display.

FIG. 13 is a view that illustrates an automobile provided with an acoustic converter according to an embodiment of the present invention.

### DETAILED DESCRIPTION

The diaphragm for acoustic converter according to an embodiment of the present invention is a diaphragm for acoustic converter that includes a base and a damping layer formed on one surface or both surfaces of the base. Specifically, the damping layer includes a particle having a heat dissipating function and the damping layer has detachability with respect to the base.

Further, the acoustic converter according to an embodiment of the present invention includes the diaphragm for acoustic converter, a vibrating body including a voice coil supported by the diaphragm for acoustic converter, a frame vibratably supporting the vibrating body and a magnetic circuit forming a magnetic gap in which the voice coil is arranged. Specifically, the damping layer including at least a particle having a heat dissipating function is formed closer to the magnetic circuit than the base of the diaphragm for acoustic converter.

Since the damping layer of the above-mentioned diaphragm for acoustic converter includes a particle having a heat dissipating function, it is possible to provide a diaphragm for acoustic converter that has a comparatively high thermolytic action. In addition, since the damping layer has detachability with respect to the base, it is possible to increase a loss tangent of the diaphragm for acoustic converter.

Further, in the above-mentioned acoustic converter, since the damping layer that includes at least a particle that have a heat dissipating function is formed closer to the magnetic circuit than the base of the diaphragm for acoustic converter, it is possible to provide an acoustic converter that has a comparatively high thermolytic action.

According to one aspect, the storage elastic modulus of the diaphragm for acoustic converter is preferably smaller than the storage elastic modulus of the base of the diaphragm for acoustic converter.

Since the storage elastic modulus of the diaphragm for acoustic converter is smaller than the storage elastic modulus of the base of the diaphragm for acoustic converter, it is possible to provide a diaphragm for acoustic converter that has a comparatively small lowest resonance frequency.

Further, according to one aspect, the loss tangent of the diaphragm for acoustic converter is preferably greater than the loss tangent of the base of the diaphragm for acoustic converter.

Since the loss tangent of the diaphragm for acoustic converter is greater than the loss tangent of the base of the diaphragm for acoustic converter, it is possible to provide a diaphragm for acoustic converter that has a comparatively great loss tangent and a comparatively small storage elastic modulus.

In addition, the diaphragm for acoustic converter that has a smaller storage elastic modulus than the storage elastic modulus of the base of the diaphragm for acoustic converter and a greater loss tangent than the loss tangent of the base of the diaphragm for acoustic converter can have a comparatively small lowest resonance frequency and a comparatively great loss tangent.

Hereinafter, the diaphragm for acoustic converter and the acoustic converter that employs the diaphragm for acoustic converter according to an embodiment of the present invention are described with reference to the drawings.

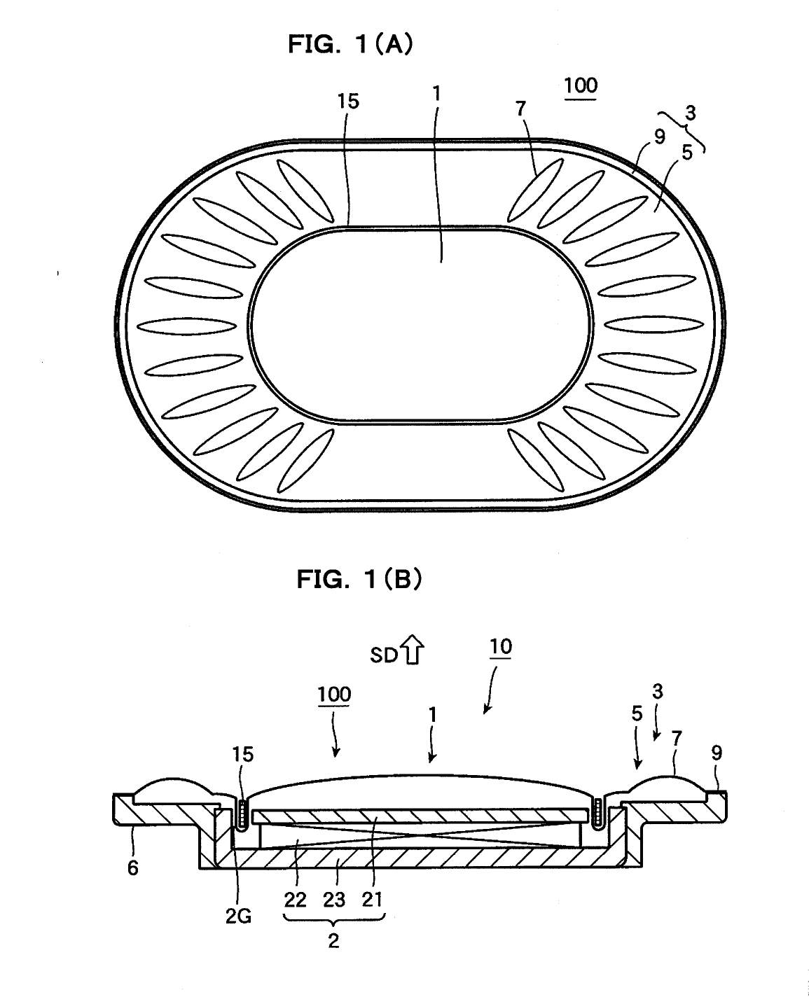

FIG. 1 is a view that illustrates an acoustic converter (speaker device) employing a diaphragm for acoustic converter according to an embodiment of the present invention. Specifically, FIG. 1(A) is a front view of the acoustic converter (speaker device) and FIG. 1(B) is a cross-sectional view of the acoustic converter (speaker device) shown in FIG. 1(A).

A speaker device, a microphone, etc. may be listed as an example of the acoustic converter. A speaker device is described as an acoustic converter according to this embodiment.

As shown in FIGS. 1(A) and 1(B), a speaker device 100 includes a vibrating body 10, a magnetic circuit 2 and a frame 6. The vibrating body 10 corresponds to an embodiment of the vibrating body according to the present invention, the magnetic circuit 2 corresponds to an embodiment of the magnetic circuit according to the present invention and the frame 6 corresponds to an embodiment of the frame according to the present invention.

The vibrating body 10 includes a diaphragm for acoustic converter (diaphragm) 1, a voice coil 15 and an edge 3. The diaphragm 1 corresponds to an embodiment of the diaphragm for acoustic converter according to the present invention.

The diaphragm 1 is formed in a specified shape such as a dome shape, a cone shape, a tabular shape and a round shape. The diaphragm 1 according to this embodiment is formed in a dome shape as shown in FIGS. 1(A) and 1(B). Specifically, the diaphragm 1 includes a diaphragm part that is formed in the center of the diaphragm and the edge 3 that is formed along the outer periphery of the diaphragm part. The diaphragm part and the edge 3 of the diaphragm 1 may be integrally molded or may be separately formed with different members.

The radially cross-sectional shape of the edge 3 is formed in a concave shape or in a convex shape. The outer periphery of the edge 3 is fixed to and supported by a frame 6 with adhesive, etc. The radially cross-sectional shape of the edge 3 according to this embodiment is formed in a convex shape in a sound emission direction (SD) as shown in FIGS. 1(A) and 1(B). The edge 3 is formed deformably in response to a vibration of the diaphragm 1.

The edge 3 includes an edge body 5 and a flange 9 according to this embodiment. The flange 9 that is formed along the outer periphery of the roll-shaped edge body 5 is fixed to the frame 6. Further, a reinforcing rib 7 is formed in the edge body 5.

The rib 7 is formed, for example by press forming in a specified shape such as a projection-like shape, a groove-like shape, etc. The rib 7 is formed substantially in a radial direction within a region not including the region near the inner periphery of the edge 3 and the region near the outer periphery. A property of the edge 3 such as a compliance, etc. may be defined as a predetermined value by an adjustment of a length, a width, a shape, etc. of the rib 7. In addition, an acoustic characteristic of the diaphragm may be further improved by providing the edge 3 with the damping layer according to the present invention.

The shape of the edge 3 is not limited to the above-mentioned embodiments, which may be formed in various shapes.

The voice coil 15 is supported by the diaphragm 1 and arranged in a magnetic gap 2G of the magnetic circuit 2. The voice coil 15 according to this embodiment is fixed to a voice coil support part that is formed with the diaphragm 1 with adhesive, etc. Further, the voice coil 15 is arranged between the diaphragm body and the edge 3, more specifically in a groove-like shape part that is formed between the diaphragm body and the edge 3 as shown in FIGS. 1(A) and 1(B). The voice coil 15 is not limited to this embodiment, which may be fixed, for example directly to the diaphragm 1 with adhesive, etc.

The magnetic circuit 2 is supported by the frame 6 and is arranged on the opposite side to the sound emission direction (SD) of the diaphragm 1. An inner-magnetic type magnetic circuit, an outer-magnetic type magnetic circuit, etc. may be employed as the magnetic circuit 2. The magnetic circuit 2 according to this embodiment employs the inner-magnetic type magnetic circuit.

Specifically, the magnetic circuit 2 includes a plate 21, a magnet 22 and a yoke 23 as shown in FIG. 1(B). The yoke 23 is formed for example with a material such as iron, metal, alloy, etc. The cross-sectional shape of the yoke 23 is formed substantially in a U-shape. The magnet 22 is formed in a tabular shape and is arranged on the yoke 23. The magnetic circuit 22 is formed for example with a permanent magnet such as a neodymium magnet, a samarium-cobalt magnet, an alnico magnet, a ferrite magnet, a rare-earth magnet, etc. The magnet 22 is magnetized along a sound emission direction (SD). The plate 21 is formed for example with a material such as iron, metal alloy, etc. The cross-sectional shape of the plate 21 is formed in a tabular shape and is arranged on the magnet 22. The magnetic gap 2G is formed between the plate 21 and the yoke 23 in the magnetic circuit 2. The voice coil 15 is arranged in the magnetic gap 2G.

The frame 6 is formed with a known material such as iron, metal or resin, etc., which supports the diaphragm 1, the magnetic circuit 2, etc. Specifically, the magnetic circuit 2 is arranged on the inner side of the frame 6 and the outer periphery of the diaphragm 1 is supported by the upper end of the frame 6 on the outer periphery of the frame 6 via the edge 3 as shown in FIG. 1(B).

In a speaker device 100 that has a configuration as described above, when an audio signal is inputted from a terminal part (not shown) that is formed in contact with the frame 6, the audio signal is inputted to the voice coil 15 that is arranged in the magnetic gap 2G of the magnetic circuit 2. Then, a Lorentz force is developed in the voice coil 15 in response to the signal. The diaphragm 1 is vibrated by the Lorentz force, and thereby a reproduced sound is emitted in a sound emission direction (SD).

Next, the diaphragm 1 is described in detail with reference to the drawings.

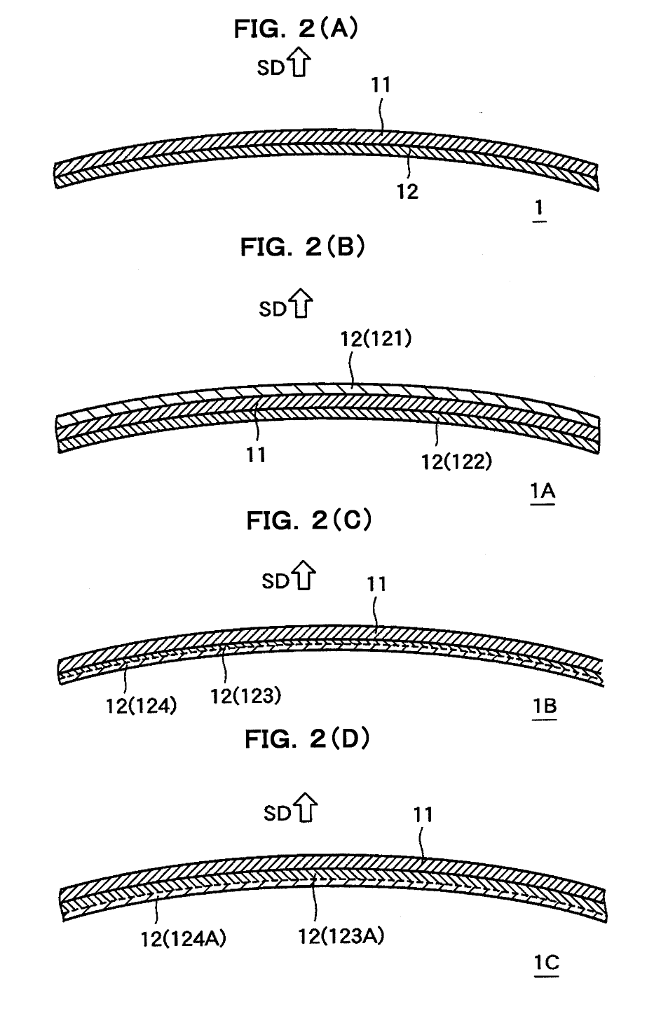

FIG. 2 is an enlarged cross-sectional view of the diaphragm for acoustic converter according to an embodiment of the present invention. Specifically, FIG. 2(A) is an enlarged cross-sectional view of the diaphragm for acoustic converter according to a first embodiment of the present invention, FIG. 2(B) is an enlarged cross-sectional view of the diaphragm for acoustic converter according to a second embodiment of the present invention, FIG. 2(C) is an enlarged cross-sectional view of the diaphragm for acoustic converter according to a third embodiment of the present invention and FIG. 2(D) is an enlarged cross-sectional view of the diaphragm for acoustic converter according to a fourth embodiment of the present invention.

The diaphragm 1 includes a base 11 and a damping layer 12. The base 11 corresponds to an embodiment of the base according to the present invention and the damping layer 12 corresponds to an embodiment of the damping layer according to the present invention.

In the diaphragm 1, the damping layer 12 is formed for example on one surface or both surfaces of the film-shaped base 11 that has low Young's modulus (low storage elastic modulus). Hereinafter, storage elastic modulus (E′) and loss tangent (tan δ) are referred to as Young's modulus and internal loss, respectively. For example, Young's modulus (E′) of the base 11 is preferably around 2.499 GPa or less. The damping layer 12 includes a damping elastomer, a charge restraining filler, etc. The damping layer 12 may have either a single layer or a plurality of layers as shown in Figs. (A) to (D).

By the way, for example, if polyethylene naphthalate (PEN) that has Young's modulus of around 6 GPa or polyetherimide (PEI) that has Young's modulus of around 2.85 GPa, etc. is employed as a base of the diaphragm, the thickness of the material is required to be ultrathin, not more than the thickness of a standard base to make a small size diaphragm, because Young's modulus of the base is comparatively high. However, if such a base is employed, the base cost may be increased and dispersion may occur in the dimensional accuracy, the properties, etc. Even if this base is provided with an elastomer layer, it is difficult to lower F0. Further, dispersion may occur in the F0 value and the acoustic characteristic of the diaphragm in which a base is simply provided with an elastomer sheet. Further, a flaw such as a swelling due to the adhesive may occur in the elastomer sheet at the time of manufacturing the diaphragm. Further, if the thickness of the base is ultrathin not more than the thickness of a standard base, resistance to input or stability of the dimensional accuracy may be lowered, and therefore it may be difficult to improve the acoustic characteristic. For example if a current value inputted to the voice coil becomes great, the amplitude and the vibration velocity of the voice coil also become great. At this time, the air resistance to the diaphragm (proportional to the vibration velocity of the diaphragm) also becomes great, and thus a deformation like a dent in the diaphragm may be caused by the effect of the air resistance. An abnormal noise may occur due to the deformation of the diaphragm, which may deteriorate the acoustic characteristic. If resistance to input is lowered, resistance to the deformation of the diaphragm as described above is lowered as well.

On the other hand, the diaphragm 1 according to an embodiment of the present invention includes a low Young's modulus base as the base 11 in which Young's modulus is an intermediate value between a common resin base and an elastomer material. Specifically, since the base 11 that has Young's modulus of around 2.35 GPa is provided with the damping layer 12 that includes a damping elastomer and a filler, etc., it is possible to lower F0, increase an internal loss and reduce a distortion of the diaphragm 1.

In other words, even if the damping layer 12 including a damping elastomer, a heat dissipating particle and a charge restraining filler is provided on one surface or both surfaces of the base 11 of the diaphragm 1, since the base 11 is formed with a material of lower Young's modulus, it is possible to lower F0, increase an internal loss and reduce a distortion of the diaphragm 1.

Hereinafter, each configuration element of the diaphragm 1 is described in detail.

### First Embodiment

The base 11 is formed with a material of low Young's modulus, for example preferably Young's modulus of 2.499 GPA or less. The base 11 according to this embodiment employs a material with Young's modulus of around 2.35 GPa.

This base 11 is formed in a film shape with film thickness of around 6 μm to around 1000 μm. Preferably, the film thickness of the base 11 is around 6 μm to 150 μm.

Further, when employing, for example a material composed mostly of polyphenylsulphon (PPSU) resin with Young's modulus of around 2.35 GPa as the base 11, the film thickness is preferably around 7 μm to 19 μm.

The film thickness is not limited to those described above, which may be properly adjusted along with the film thickness of the base 11, damping layer 12 and diaphragm 1, and acoustic characteristic.

Further, conventional materials such as aromatic-system resin, polysulphone resin, polybiphenylsulphone resin, etc. may be employed as formation material of the base 11. Further, a mixture of resin materials with mutually different peak temperatures of internal loss or glass transition temperatures, for example, a mixture of polysulphone resin with glass transition temperature of around 200° C. and polyurethane resin material with glass transition temperature of around 130° C. may be employed. Further, a co-polymer having a structure unit of a plurality of polymers with mutually different peak temperatures of internal loss or glass transition temperatures may be employed as well. The diaphragm 1 including the base 11 that employs aromatic-system resin material comparatively high heat resistance (comparatively high glass transition temperature) and comparatively high tensile strength (depending on orientation). In addition, the diaphragm 1 may have comparatively great loss tangent by employing an aliphatic-system resin for the damping layer 12.

The diaphragm 1 including base 11 that employs a polysulphone resin material may have comparatively greater internal loss (loss tangent) and comparatively smaller Young's modulus (storage elastic modulus) compared to polyetherimide and polyethylene naphthalate, and thus it may create a preferable acoustic characteristic.

Further the diaphragm 1 including the base 11 that employs a mixture of resin materials with mutually different glass transition temperatures, may have comparatively small Young's modulus (storage elastic modulus) and comparatively great internal loss (loss tangent), and thus it may create a preferable acoustic characteristic. Further, since each material has mutually different glass transition temperature, the diaphragm 1 may have comparatively high internal loss (loss tangent) ranging from low to high temperatures, and thus a significant change in an acoustic characteristic due to a change of surrounding environment (temperature change) may be restrained.

Further, base 11 may be formed so as to include a structure unit including a thermoplastic resin as one of formation materials, which includes an aromatic nucleous bond, a sulphone bond, an ether bond or a phenyl bond.

The damping layer 12 is formed on one surface or both surfaces of the base 11. The damping layer 12 includes a particle (filler) having, for example, a heat dissipating function.

The damping layer 12 may employ, for example, an aliphatic-system resin, more specifically a polyurethane-system resin, an epoxy-system resin, a mixture of polypropylene-system resin and styrene-system resin, a polyether-system resin, a silicon-system resin, a polyamide-system resin, a co-polymer of ethylene-vinyl acetate rubber, a polymethacrylate-system resin, a mixture or co-polymer of these, etc. Further, the damping layer 12 may be a mixture of selected resin materials that have mutually different peak temperatures of internal loss or glass transition temperatures, or co-polymer having a structure unit of a plurality of polymers that have mutually different peak temperatures of internal loss or glass transition temperatures. For example, if the damping layer 12 is formed with a mixture of a resin A having a high peak temperature of internal loss and a resin B having a low peak temperature of internal loss, the internal loss of the resin A is expected to significantly decrease in the temperature range lower than the peak temperature of the resin A. However, since the peak temperature of the resin B is lower than the peak temperature of the resin A, the drop in internal loss of the resin A may be compensated, and thus the internal loss of the overall diaphragm 1 may be maintained comparatively large over a comparatively broad temperature range.

Specifically, the damping layer 12 may employ, for example, a mixture or co-polymer of polypropylene and a styrene-system resin. More specifically, the damping layer 12 may employ, for example, a styrene-system thermoplastic resin called Hybler 5127 (HYB), etc. made by Kuraray Co., Ltd.

For example, mica, oxidized silicon, etc. may be employed as a particle having a heat dissipating function. With the damping layer including this particle having a heat dissipating function, the diaphragm 1, which has a comparatively high thermolytic action, may be obtained. Further, by restraining temperature rise in the diaphragm 1, acoustic characteristic deterioration due to heat may be restrained.

Further, a particle having a charge restraining function may be included in the damping layer 12. A material such as tin oxide may be employed as a particle having the charge restraining function. With the particle having the charge restraining function included in the damping layer 12, releasing property is comparatively improved, for example, when the diaphragm 1 is taken out of a die after die pressing, and thus dispersion of acoustic characteristic may be reduced.

Carbon black, silica, calcium carbonate, synthesized silicic acid and silicate salt, zinc flower, halloysite clay, kaolin, basic magnesium carbonate, mica, talc, quartz powder, wollastonite, dolomite powder, titanium oxide, barium sulfate, calcium sulfate, alumina, etc. may be listed as a particle having the heat dissipating function or a particle having the charge restraining function other than examples as mentioned above.

Further, for example a particle having the heat dissipating function may be employed as a particle having the charge restraining function, and a comparatively large concavo-convex shape is formed at the surface of the diaphragm 1, and thus releasing property may be provided.

Further, a particle with metal-element may also be employed as a particle having the heat dissipating function and a particle having the charge restraining function, and these particles with metal-element may be spaced apart from each other on the surface of the base or may be a membrane, a net structure or a mixed structure of these.

The damping layer 12 is formed for example in a film shape with film thickness of around 20 μm to 100 μm. The thickness of the damping layer 12 is preferably, for example, around 0.4 to 1.5 times as the base 11. If the film thickness of the damping layer 12 is around 0.4 to 1.5 times as the base 11, the loss tangent of the diaphragm 1 becomes comparatively great, and thus unwanted vibrations generated in the diaphragm 1 may be sufficiently subdued.

If the damping layer 12 is formed on the opposite side to sound emission direction SD, specifically closer to the magnetic circuit than the base 11 as shown in FIG. 2 (A), the configuration of the diaphragm 1 is preferable because Joule heat dissipation and damping property of the diaphragm 1 are comparatively high.

Further, since a diaphragm 1A includes a damping layer 12(121) on the sound emission direction (SD) side of the base 11 and a damping layer 12(122) on the opposite side to sound emission direction (SD) side as shown in FIG. 2(B), higher heat dissipation and damping property may be obtained.

Further, the damping layer 12 has a laminate structure of a plurality of layers laminated, and in the plurality of layers of the damping layer 12, a layer formed on the side of the base has a smaller density of particles having a heat dissipating function than a layer formed on the side of the magnetic circuit. The term “density” here is, for example, a ratio of the total weight of the particles having a heat dissipating function included in the layer formed on the side of the base with respect to the total weight of the layer formed on the side of the base.

More specifically, the density of particles having a heat dissipating function is smaller in a first layer 12 (123) formed on the side of the base than in a second layer 12(124) formed on the side of magnetic circuit, for example as shown in FIG. 2(C). In other words, the density of particles having a heat dissipating function is comparatively great in the second layer 12(124) formed on the side of the magnetic circuit. As such, heat dissipation of the diaphragm 1 is comparatively high. Further, since a concavo-convex shape is formed on the surface of the diaphragm 1, releasing property of the diaphragm 1 is comparatively high (adhesion to a die is comparatively small), and thereby, for example the diaphragm 1 may be formed more easily. In particular, since the surface of the diaphragm 1 (on the side of the magnetic circuit) has comparatively high rigidity, the diaphragm 1 has a comparatively high damping function, and thus unwanted vibration may be further reduced.

The damping layer 12 of the diaphragm 1C may be formed in a plurality of cover layers 12 (124A) sandwiching an inner layer 12 (123A) therebetween as shown in FIG. 2(D). The cover layers 12 (124A) may be coating layers with a comparatively higher heat dissipation and charge restraining function, etc. than the inner layer 12 (123A).

Further, the damping layer 12 of the diaphragm 1C may be formed in a single layer and properly adjusted such that the density of particles having a heat dissipating function increases from the base side to the magnetic circuit side. The term “density” here means a ratio of the total weight of the particles having a heat dissipating function included in each divided layer of the damping layer with respect to the total weight of the each divided layer of the damping layer. Further, the density of the particles having a charge restraining function may be adjusted within the damping layer 12 as necessary in the similar way as the density of the particles having a heat dissipating function.

Preferably, at least one resin material configuring the damping layer 12 is a resin material having a peak temperature of internal loss (loss tangent), which is around 0° C. or higher, as described below. Generally, since usage environment of a speaker device is at room temperature of around 20° C. or higher temperature ranges, if a material with a peak temperature of internal loss (loss tangent), which is higher than 0° C., is employed as the material of the damping layer 12, the internal loss (loss tangent) of the damping layer 12 at room temperature (for example around 20° C.) is comparatively high, and thus unwanted vibration generated in the diaphragm 1 may be reduced.

Furthermore, at least one resin material configuring the damping layer 12 is preferably a resin material having a peak temperature of internal loss (loss tangent) that is around 30° C. or lower. If a material having a peak temperature of internal loss (loss tangent), which is around 30° C. or lower, is employed as the material of the damping layer 12, the internal loss (loss tangent) of the damping layer 12 at room temperature (for example around 30° C.) is comparatively high, and thus unwanted vibration generated in the diaphragm 1 may be reduced.

Further, for example, the peak temperature of internal loss (loss tangent) in the damping layer 12 is preferably lower than the peak temperature of internal loss (loss tangent) in the base 11, as described below. If the peak temperature of the internal loss (loss tangent) in the damping layer 12 is lower than the peak temperature in the base 11, the internal loss may be adjusted comparatively greater over a range of temperature lower than a peak temperature of internal loss (loss tangent) of the base, and thus unwanted vibration of the diaphragm 1 may be further efficiently restrained. In particular, over a temperature range lower than a peak temperature of internal loss (loss tangent) of the base, while the internal loss of the base is significantly dropped, the internal loss of the overall diaphragm 1 may be maintained greater, since the peak temperature of internal loss (loss tangent) of the damping layer is lower than the peak temperature of internal loss (loss tangent) of the base. The peak temperature of the internal loss (loss tangent) is substantially the same temperature as a glass transition temperature.

In the diaphragm 1 of the above configuration, Young's modulus (storage elastic modulus) of the diaphragm 1 is preferably smaller than Young's modulus (storage elastic modulus) of the base 11 of the diaphragm 1. Specifically, Young's modulus (storage elastic modulus) of the diaphragm 1 is preferably smaller than Young's modulus (storage elastic modulus) of the base 11 formed, for example substantially in the same thickness as the diaphragm 1. The diaphragm 1 of the above configuration may obtain comparatively small Young's modulus (storage elastic modulus).

Further, in the diaphragm 1, the internal loss (loss tangent) of the diaphragm 1 is preferably greater than the internal loss (loss tangent) of the base 11 of the diaphragm 1. Specifically, the internal loss (loss tangent) of the diaphragm 1 is preferably greater than the internal loss (loss tangent) of the base 11 formed, for example, substantially in the same thickness as the diaphragm 1. The diaphragm 1 of the above configuration may obtain comparatively great internal loss (loss tangent).

Further, more specifically, in the diaphragm 1, the internal loss (loss tangent) of the diaphragm 1 at room temperature of 20° C. is preferably greater than, for example, a polyetherimide film having substantially the same thickness as the diaphragm 1, and Young's modulus (storage elastic modulus) of the diaphragm 1 at room temperature 20° C. in resonance frequency is preferably smaller than, for example, polyethylene naphthalate having substantially the same thickness as the diaphragm 1. The diaphragm 1 of the above configuration may obtain comparatively small Young's modulus (storage elastic modulus) and comparatively great internal loss (loss tangent).

The above-mentioned internal loss (loss tangent), and Young's modulus (storage elastic modulus) may employ characteristic values measured at preliminary specified frequencies near the lowest resonance frequency, for example, such as the lowest resonance frequency, a second resonance frequency, frequency 1 Hz, etc. as described below.

### [A Method of Manufacturing Diaphragm for Acoustic Converter]

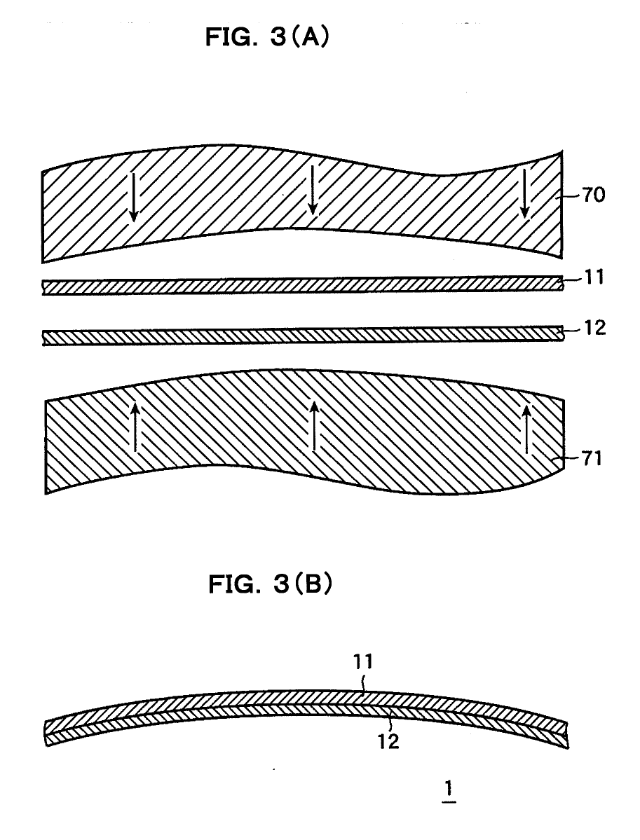

FIG. 3(A) is a view that illustrates a method of manufacturing the diaphragm for acoustic converter shown in FIG. 2(A) according to an embodiment, and FIG. 3(B) is a cross-sectional view of the diaphragm for acoustic converter made by die pressing shown in FIG. 3(A). The diaphragm 1 is formed by a method of manufacturing diaphragm, for example, by die pressing, vacuum forming, etc.

Specifically, for example as shown in FIG. 3(A), the diaphragm 1 as shown in FIG. 3(B) and FIG. 2(A) is formed by pressure forming (laminating) the base 11 and the damping layer 12 in a sheet shape with dies 70, 71. Adhesion may be strengthened by applying a specified adhesive, etc. between the base 11 and the damping layer 12 when forming the diaphragm 1.

Further, since the damping layer 12 includes a particle having a charge restraining function, a particle having a heat dissipating function, etc., releasing property from die 70, 71 is comparatively high, and since adhesion to the die is comparatively small, manufacturability is improved. In particular, when manufacturing a complex-shaped diaphragm 1 such as a diaphragm with a rib, etc. manufacturing efficiency is comparatively improved, since releasing property is comparatively high. In addition, dispersion of acoustic characteristic of the diaphragm 1 may be reduced.

Further, the diaphragm 1 according to the present invention may be easily manufactured by die pressing the sheet-shaped damping layer 12 that includes a particle having a charge restraining function and a particle having a heat dissipating function, etc., and the sheet-shaped base 11.

The method of manufacturing the diaphragm 1 is not limited to the above-mentioned embodiments. For example, the damping layer 12 may be formed by coating to the base 11.

### Second Embodiment

The second embodiment is substantially the same as the embodiment 1 except materials used for the base 11 and the method of forming the damping layer, and therefore the description relating to substantially the same as the embodiment 1 is omitted.

The base 11 used in this embodiment is configured mainly with a polyester-system elastomer. Further, the base 11 may be formed with a mixture of a polyester-system elastomer and a known thermoplastic resin, etc.

The polyester-system elastomer may employ a polyester-polyether type elastomer having a hard segment of aromatic polyester and a soft segment of aliphatic polyether, and a polyester-polyester type elastomer having a hard segment of aromatic polyester and a soft segment of aliphatic polyester. For example, Hytrel, etc. made by Toray-DuPont is listed as a product of the polyester elastomer.

Young's modulus (storage elastic modulus) of the base 11 used for this embodiment is 2.499 GPa or less, for example 0.115 GPa to 0.175 GPa.

A peak temperature of internal loss (loss tangent) of the base 11 used for this embodiment is −20° C.

Further, the base 11 is formed in a film shape with film thickness of around 20 μm to around 60 μm. Further, the thickness of the damping layer 12 that is formed on the base 11 is formed around 6 μm.

The damping layer 12 used in this embodiment is formed by applying a material forming the damping layer 12 onto the base 11. The base 11 with the damping layer 12 formed thereon is then die pressed and formed.

### [Measuring a Property of a Diaphragm]

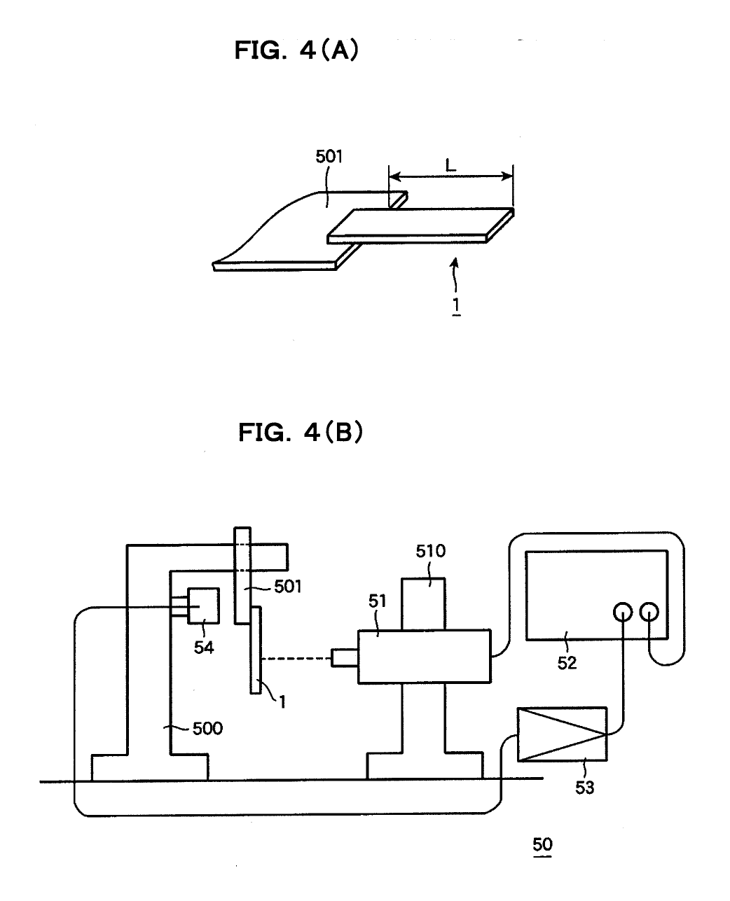

FIG. 4(A) is a view that illustrates a measuring instrument 50 and a diaphragm 1. FIG. 4(B) is a view that illustrates the whole measuring instrument 50.

The measuring instrument 50 shown in FIG. 4(A) and FIG. 4(B) measures and calculates Young's modulus (E′) and internal loss (tan δ) by cantilever method.

Specifically, the measuring instrument 50 has a laser Doppler accelerometer 51, a frequency analyzer 52, an electromagnetic induction type coil 54, an amplifier 53, an attaching counterpart (metal member) 501, a support part 500, a support part 510, etc.

As shown in FIG. 4(A) and FIG. 4(B), one end of the diaphragm 1 is fixed to the end of a tabular attaching counterpart 501 such that the other end of the diaphragm 1 becomes a free end with adhesive. Further, the attaching counterpart 501 is fixed to the support part 500 such that the measuring surface of the diaphragm 1 is opposed to the laser Doppler accelerometer 51. The electromagnetic induction type coil 54 is provided on the support part 500 near the attaching counterpart 501 made from metal. The electromagnetic induction type coil 54 is electrically connected to the frequency analyzer 52 via the amplifier 53. The laser Doppler accelerometer 51 is fixed to the support part 510 and its measuring signal is inputted to the frequency analyzer 52.

In the measuring instrument 50 configured as above, if a driving signal is inputted to the electromagnetic induction type coil 54, as the attaching counterpart 501 vibrates, the diaphragm 1 vibrates. A signal corresponding to the driving signal of the electromagnetic induction type coil 54 is amplified by the amplifier 53 and inputted to the frequency analyzer 52.

The laser Doppler accelerometer 51 emits a laser beam onto the diaphragm 1 and receives a reflected light from the diaphragm 1, thereby outputting a measuring signal corresponding to the intensity of receiving light to the frequency analyzer 52.

The frequency analyzer 52 calculates Young's modulus (E′) and internal loss (tan δ) of the diaphragm 1 based on vibrations from the laser Doppler accelerometer 51 and from the electromagnetic induction type coil 54.

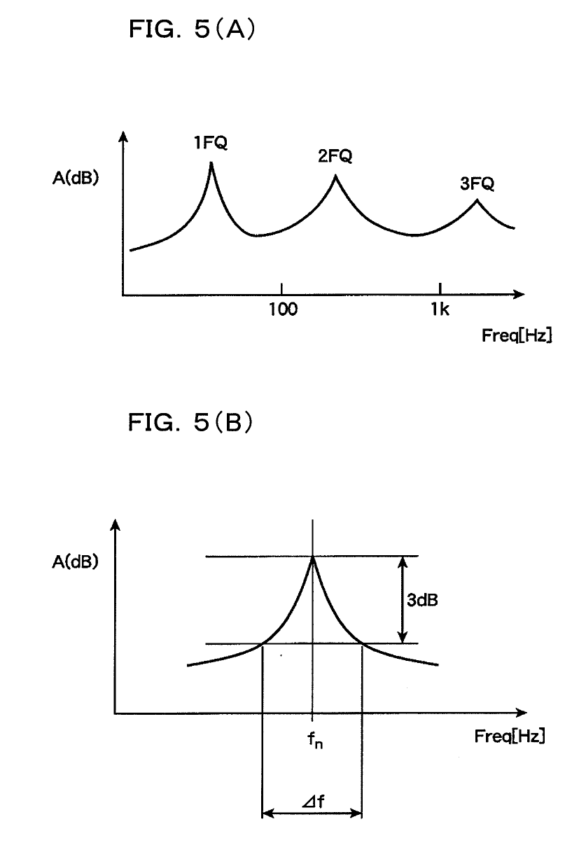

FIG. 5(A) is a view that illustrates a frequency characteristic of the vibration acceleration of a diaphragm measured by the measuring instrument 50. In FIG. 5(A), the vertical axis represents acceleration (A) (unit dB: decibel) and the horizontal axis represents frequency (Freq) (unit: Hz). FIG. 5(B) is a view that illustrates a method of measuring Young's modulus (E′) and internal loss (tan δ) by half width method.

As shown in FIG. 5(A), peaks occur at a first resonance frequency (1 FQ), a second resonance frequency (2 FQ), and a third resonance frequency (3 FQ) and so on.

N-th order resonance frequency fn (Hz) and half width Δf are calculated based on peak shapes at each resonance point by using this measured results as shown in FIG. 5(A) and FIG. 5(B).

Young's modulus (E′) and internal loss (tan δ) can be calculated as shown in equation (1) and equation (2) respectively, by using the length of a diaphragm L (m) (bonded part excluded), the thickness of the a strip of a sample (diaphragm) h (m), density ρ (kg/m³) and constant aₙ corresponding to the resonance mode number, where constant a₁² is 3.52, constant a₂² is 22.0, constant a₃² is 61.7, constant a₄² is 121 and constant a₅² is 200.

$$\begin{matrix}[ Equation 1 ] & \\ {E}^{′} = 48 π ρ \frac{{L}^{4} {f}_{n}^{2}}{{h}^{2} {a}_{n}^{4}} & ( 1 ) \\ [ Equation 2 ] & \\ tan δ = \frac{Δ f}{{f}_{n}} & ( 2 )\end{matrix}$$

Hereinafter, the diaphragm 1, the base 11 and the damping layer 12 according to an embodiment of the present invention, and properties of polyethylene naphthalate (PEN), polyetherimide (PEI), etc. as characteristics are described in conjunction with the drawings.

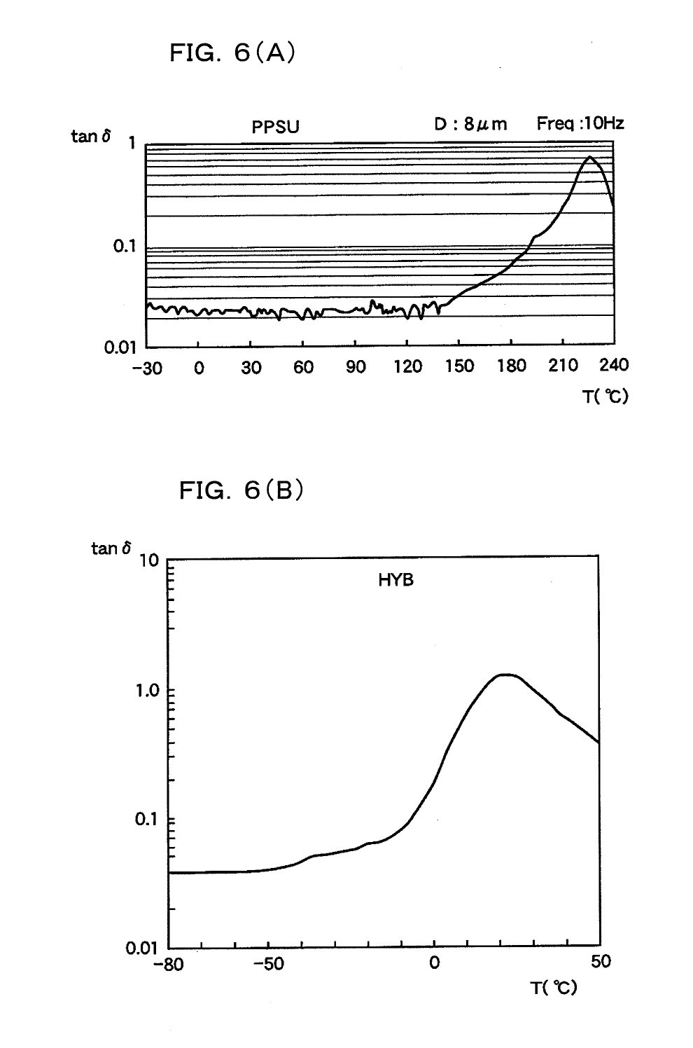

FIG. 6(A) is a view that illustrates a temperature characteristic of the internal loss (loss tangent (tan δ)) of polyphenylsulphon (PPSU). The vertical axis represents internal loss (loss tangent (tan δ)) while the horizontal axis represents temperature (T: unit ° C.). The measurement condition, in which the thickness (D) of PPSU is 8 μm and the frequency (Freq) is 10 Hz, is applied. FIG. 6(B) is a view that illustrates a temperature characteristic of the internal loss (loss tangent (tan δ)) of Hybler (HYB).

The peak temperature of internal loss (loss tangent (tan δ)) of, for example PPSU, which is one of main forming materials of the base 11, is approximately 226° C. as shown in FIG. 6(A). On the other hand, the peak temperature of internal loss (loss tangent (tan δ)) of Hybler (HYB), which is one of main forming materials of the damping layer 12, is approximately 20° C. as shown in FIG. 6(B).

As such, in the diaphragm 1, the peak temperature of internal loss (loss tangent (tan δ)) of the main forming material of the damping layer 12 is smaller than the peak temperature of internal loss (loss tangent (tan δ)) of the main forming material of the base 11 of the diaphragm 1. The peak temperature is substantially the same as the glass transition temperature. Accordingly, the diaphragm 1 may reduce unwanted vibration more efficiently with the damping layer 12 at room temperature (around 20° C.), which is a general usage environment.

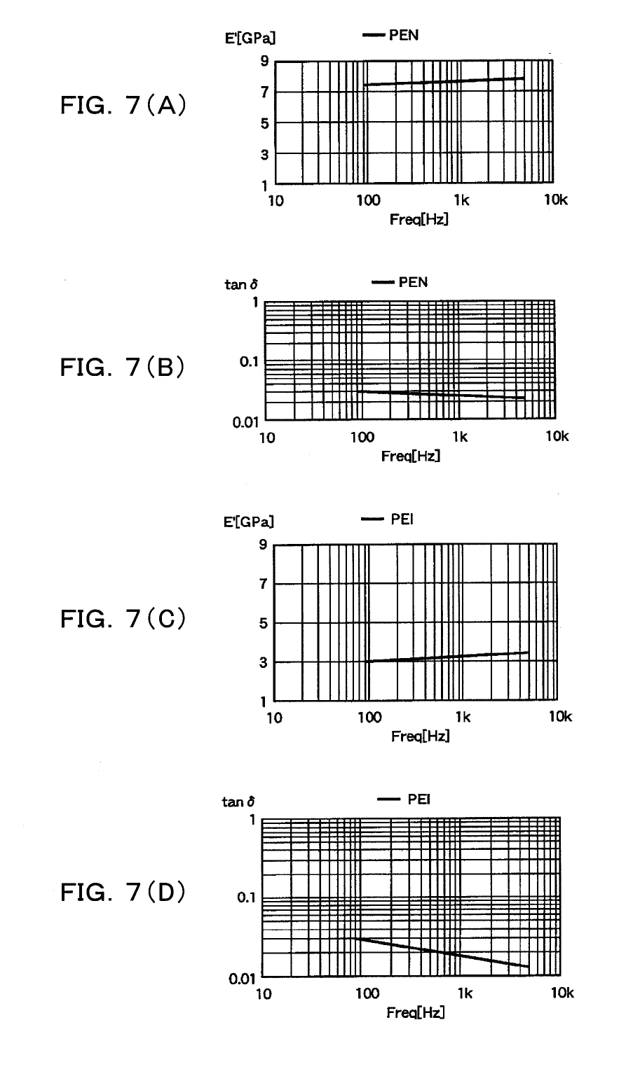

FIG. 7(A) is a view that illustrates a frequency characteristic of Young's modulus (storage elastic modulus (E′)) of PEN, FIG. 7(B) is a view that illustrates a frequency characteristic of the internal loss (loss tangent (tan δ)) of PEN. FIG. 7(C) is a view that illustrates a frequency characteristic of Young's modulus (storage elastic modulus (E′)) of PEI, and FIG. 7(D) is a view that illustrates a frequency characteristic of the internal loss (loss tangent (tan δ)) of PEI.

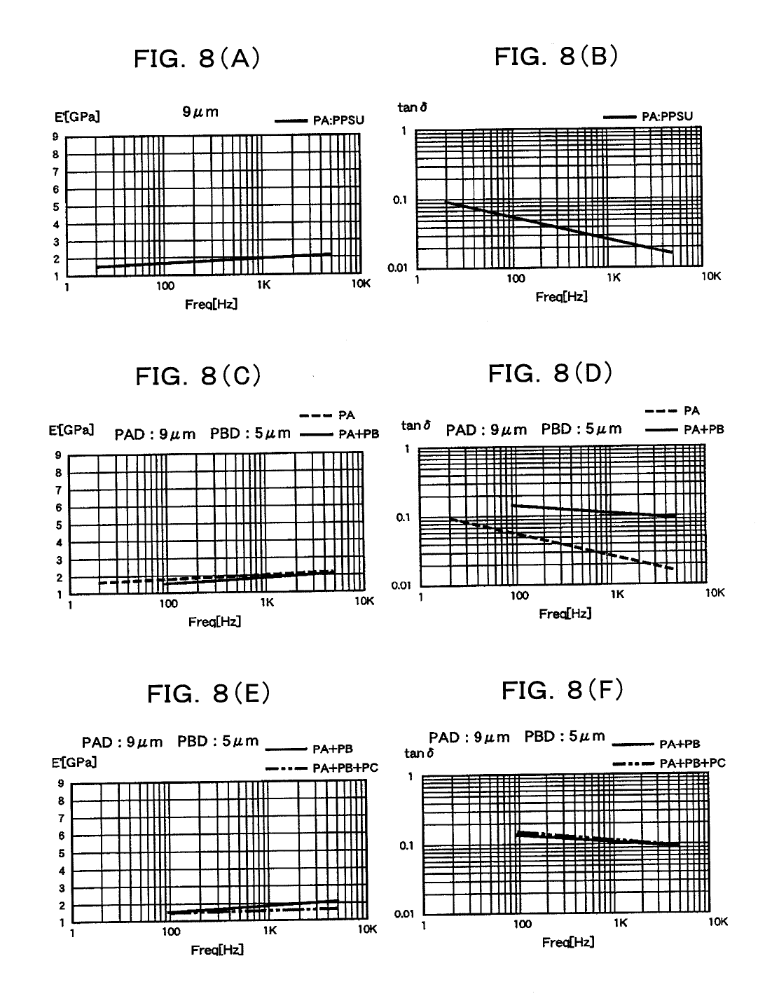

FIG. 8(A) is a view that illustrates a frequency characteristic of Young's modulus (storage elastic modulus (E′)) of PPSU. FIG. 8(B) is a view that illustrates a frequency characteristic of the internal loss (loss tangent (tan δ)) of PPSU. FIG. 8(C) is a view that illustrates a frequency characteristic of Young's modulus (storage elastic modulus (E′)) of a diaphragm that has only a base and a diaphragm that has a base and a damping layer. FIG. 8(D) is a view that illustrates a frequency characteristic of the internal loss (loss tangent (tan δ)) of a diaphragm that has only a base and a diaphragm that has a base and a damping layer. FIG. 8(E) is a view that illustrates a frequency characteristic of Young's modulus (storage elastic modulus (E′)) of a diaphragm that has a base (PA), a damping layer (PB), and a diaphragm that includes a base (PA) and a damping layer (PB) containing a heat dissipating particle (PC). FIG. 8(F) is a view that illustrates a frequency characteristic of the internal loss (loss tangent (tan δ)) of a diaphragm that has the base (PA), the damping layer (PB), and a diaphragm that includes the base (PA) and the damping layer (PB) having the heat dissipating particle (PC).

In FIGS. 8(A) and 8(B), the thickness of PPSU (RA) of the comparative example is 9 μm, while in FIGS. 8(C) to 8(F), the thickness (PAD) of the base (PA) is 9 μm and the thickness (PBD) of the damping layer (PB) is 5 μm.

Young's modulus (storage elastic modulus (E′)) of the diaphragm 1 according to an embodiment of the present invention at room temperature 20° C. as shown in FIG. 8(A) is smaller than Young's modulus (storage elastic modulus) of PEN and PEI as comparative examples as shown in FIGS. 7(A) and 7(C), which is specifically around 2 GPa.

The loss tangent (tan δ) of the diaphragm 1 according to an embodiment of the present invention at room temperature 20° C. as shown in FIG. 8(B) is greater than the internal loss (loss tangent (tan δ)) of PEN and PEI as comparative examples as shown in FIGS. 7(B) and 7(D).

Young's modulus (storage elastic modulus (E′)) of the diaphragm 1 as shown in FIGS. 8(C) and 8(E) is smaller than Young's modulus (storage elastic modulus (E′)) of the base of the diaphragm for acoustic converter as shown in FIG. 8(A).

Further, Young's modulus (storage elastic modulus (E′)) is comparatively small in the diaphragm 1, in which the damping layer 12 includes a particle having a heat dissipating function as shown in FIGS. 8(C) and 8(E).

Further, internal loss (loss tangent (tan δ)) of the diaphragm 1 as shown in FIGS. 8(D) and 8(F) is greater than internal loss (loss tangent (tan δ)) of the base of the diaphragm for acoustic converter as shown in FIG. 8(B).

Further, internal loss (loss tangent (tan δ)) is comparatively great in the diaphragm 1 as shown in FIGS. 8(D) and 8(F) in which the damping layer 12 includes a particle having a heat dissipating function.

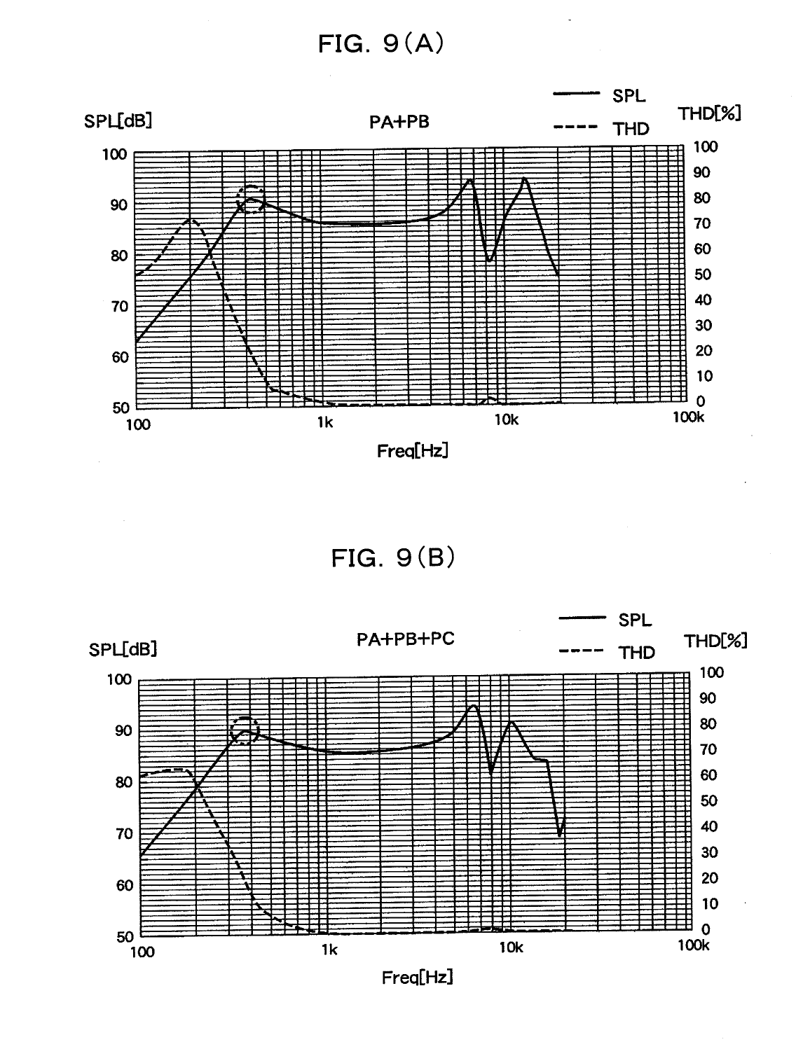

FIG. 9(A) is a view that illustrates a frequency characteristic of output sound pressure of a diaphragm that has the base (PA) and the damping layer (PB).

FIG. 9(B) is a view that illustrates a frequency characteristic of output sound pressure of a diaphragm that has the base (PA) and the damping layer (PB) including the heat dissipating particle (PC). Specifically, a solid line represents SPL (Sound Pressure Level) and a dotted line represents THD (distortion rate). The left vertical axis represents SPL (unit dB (decibel)), the right vertical axis represents THD and the horizontal axis represents frequency (unit Hz), where THD (distortion rate, %) is 100× output sound pressure (dB) of harmonic component/output sound pressure (dB) at a specified frequency and the harmonic component includes a high-order harmonic component such as a second-order harmonic and a third-order harmonic, etc.

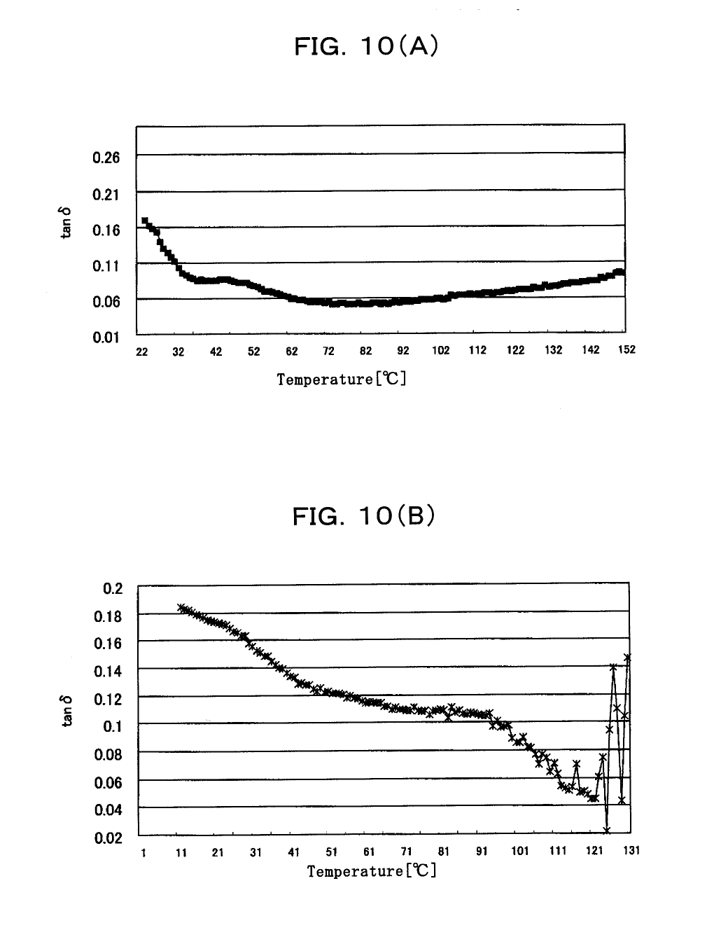

FIG. 10 (A) is a view that illustrates temperature dependence of the internal loss (loss tangent (tan δ)) in the diaphragm that includes a base (PA) mainly using PPSU and a damping layer (PB) including a heat dissipating particle (PC).

FIG. 10(B) is a view that illustrates temperature dependence of the internal loss (loss tangent (tan δ)) in the diaphragm that includes a base (PA) mainly using polyester elastomer and a damping layer (PB) having a heat dissipating particle (PC).

In FIGS. 10(A) and 10(B), the vertical axis represents internal loss (loss tangent (tan δ)) and the horizontal axis represents temperature (T: unit ° C.). The measurement condition, in which the thickness (D) of the base (PA) is 8 μm and the frequency (Freq) is 10 Hz, is selected.

FIGS. 10(A) and 10(B) show that since the diaphragm 1 includes a plurality of peak temperatures of tan δ, the internal loss (loss tangent (tan δ)) can be maintained comparatively great without any significant drop in a temperature range (from 20° C. to 80° C.) that is particularly a usage environment of a speaker device.

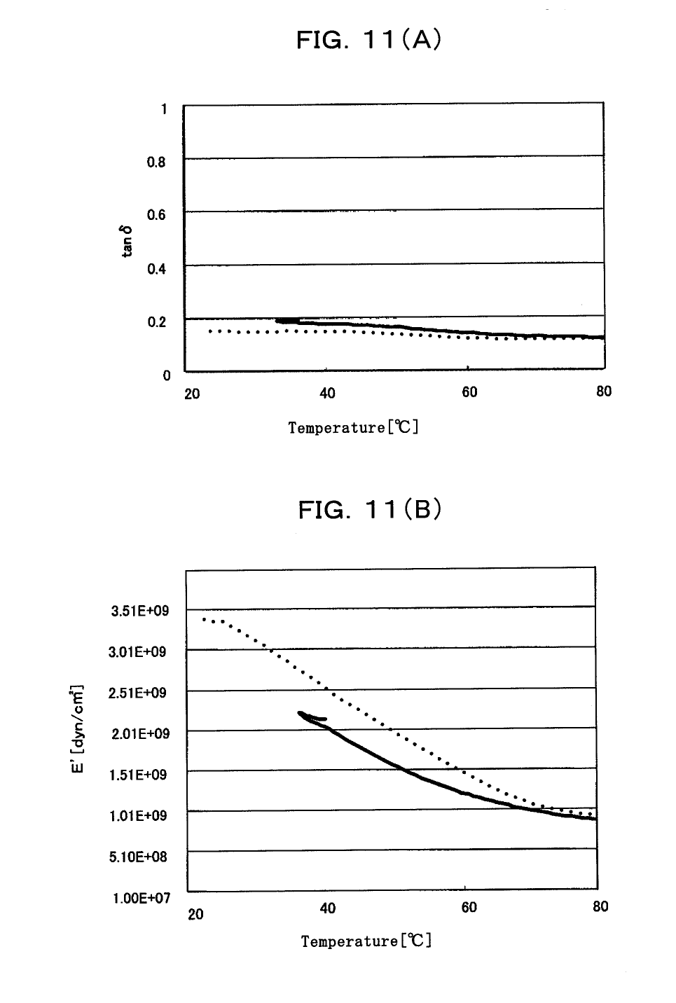

FIG. 11(A) is a view that shows temperature dependence of the internal loss (loss tangent (tan δ)) of the diaphragm that solely includes the base (PA) mainly using polyester—system elastomer, and the diaphragm that has the base (PA) mainly using a polyester-system elastomer and the damping layer (PB) including a heat dissipating particle (PC). The broken line shows experimental data of internal loss in the diaphragm having solely the base while the solid line shows experimental data of internal loss in the diaphragm having the base and the damping layer.

FIG. 11(B) is a view that shows temperature dependence of Young's modulus (storage elastic modulus (E′)) of the diaphragm that solely includes the base (PA) mainly using polyester-system elastomer, and the diaphragm that includes the base (PA) mainly using a polyester-system elastomer and the damping layer (PB) including a heat dissipating particle (PC). The broken line shows experimental data of storage elastic modulus in the diaphragm having solely the base while the solid line shows experimental data of storage elastic modulus in the diaphragm having the base and the damping layer.

In FIG. 11(A), the vertical axis represents internal loss (loss tangent (tan δ)) and the horizontal axis represents temperature (T: unit ° C.). The measurement condition, in which the thickness (D) of the base (PA) is 8 μm and frequency (Freq) is 10 Hz, is selected.

In FIG. 11(B), the vertical axis represents Young's modulus (storage elastic modulus (E′)) and the horizontal axis represents temperature (T: unit ° C.). The measurement condition, in which the thickness (D) of the base (PA) is 8 μm and frequency (Freq) is 10 Hz, is selected.

Since the damping layer 12 includes particles (filler, etc.) having a heat dissipating function, the diaphragm 1 having the base 11 and the damping layer 12 may have a more preferable property than the diaphragm 1 having only the base, even if the temperature of the diaphragm 1 itself is increased as shown in FIGS. 11(A) and 11(B). In an embodiment according to the present invention, in which the damping layer 12 includes a particles having a heat dissipating function, particularly since Young's modulus (storage elastic modulus) is comparatively small and internal loss (loss tangent) is comparatively great, a change in an acoustic characteristic along with a temperature rise after the beginning of driving a speaker device may be restrained.

In the diaphragm 1, which includes a damping layer (PB) including a heat dissipating particle (PC), a more preferable output sound pressure characteristic and distortion rate is preferable compared to that in the diaphragm including only the base (PA) and the damping layer (PB) as shown in FIGS. 9(A) and 9(B). Specifically, it can be seen that a lowest resonance frequency becomes small and the peak value of the lowest resonance frequency becomes small, and thus the output sound pressure characteristic becomes preferable. Further, it can be seen that the peak value of the lowest resonance frequency becomes small and peak-dip at high-tone range becomes small, and thus the output sound pressure characteristic in a reproduction band ranging from near 5 kHz to near 10 kHz becomes preferable. Further, since distortion rate is reduced specifically from near 150 Hz to high-tone range, it can be seen that an acoustic characteristic from low tone range to high-tone range becomes preferable. Furthermore, since distortion rate is reduced, it can be seen that generation of unwanted vibration in the diaphragm 1 is restrained by the damping layer provided on the diaphragm 1.

In the case of manufacturing the diaphragm 1, the releasing property when the diaphragm is cooled down at a specified cooling temperature (TB) after heat-pressing the diaphragm at a specified molding temperature (TA), is described with reference to Table 1. In Table 1, a mark ∘ represents comparatively high releasing property while a mark X represents comparatively low releasing property, respectively.

As shown in Table 1, the releasing property in the diaphragm 1, in which the damping layer (PB) includes a heat dissipating particle (PC), is more preferable than the releasing property in the diaphragm including only base (PA) and damping layer (PB). In particular, the releasing property may be comparatively high, without dropping even when the molding temperature is high.

| | | TB | | |
|---|---|---|---|---|
| | TA | 120° C. | 140° C. | 160° C. |
| PA + | 190° C. | ◯ | X | X |
| PB | 200° C. | ◯ | X | X |
| | 220° C. | X | X | X |
| PA + | 190° C. | ◯ | ◯ | ◯ |
| PB + | 200° C. | ◯ | ◯ | X |
| PC | 220° C. | ◯ | X | X |

As described above, the diaphragm for acoustic converter 1 according to the present invention includes the base 11 and the damping layer 12 that is formed on one surface or both surfaces of the base 11. The damping layer 12 includes a particle having a heat dissipating function, and thereby having a comparatively high heat dissipation.

Further, since the damping layer 12 includes a material having the peak temperature of internal loss (loss tangent (tan δ)) lower than the base (polyphenylsulphon resin), Young's modulus (storage elastic modulus) may be small while internal loss (loss tangent) may be great in the diaphragm for acoustic converter. Thus, the lowest resonance frequency (F0) may be comparatively small, and thus unwanted vibration (divided vibration, etc.) generated in the diaphragm for acoustic converter may be restrained. Further, peak-dip of high-tone range may be reduced and the frequency characteristic of output sound pressure may be improved at high-tone range.

Further, by employing PPSU for the base 11, tensile elongation (fracture elongation) becomes comparatively great, and thus the diaphragm for acoustic converter may be prevented from getting fractured. In particular, since polyetherimide (PEI) has a comparatively low tensile elongation, the diaphragm for acoustic converter may be subject to fracture.

Further, since particles (filler, etc.) having a heat dissipating function are included in the damping layer 12, it is possible to restrain a change in properties of the base and the damping layer such as (Young's modulus (storage elastic modulus) and internal loss (loss tangent), etc.) due to a temperature rise of the diaphragm itself for acoustic converter while a speaker device is driven for a long time. Accordingly, providing an acoustic characteristic different from those provided when the speaker device is driven may be restrained.

Since particles having a heat dissipating function and particles having a charge restraining function are included in the damping layer 12, a concavo-convex shape is formed on a cover layer of the damping layer, which may provide preferable formability of the diaphragm for acoustic converter. Specifically, the concavo-convex shape formed on the cover layer of the damping layer may decrease an area where a resin configuring the damping layer and a die are in close contact with each other, and thereby adhesion between the die and the damping layer may be reduced.

Further, since particles having a heat dissipating function and particles having a charge restraining function are included in the damping layer 12, releasing property is improved and unwanted vibration may be further reduced by the damping layer. Specifically, if releasing property is low or adhesion is great, unwanted vibration is easily transmitted from the damping layer to the base, and thus it becomes difficult to provide a preferable acoustic characteristic.

Further, since particles having a heat dissipating function are included in the damping layer, internal loss (loss tangent) may be increased and peak-dip at high-tone range may be reduced. Further, Young's modulus (storage elastic modulus) may be reduced, while the lowest resonance frequency may be reduced.

Further, since particles having a heat dissipating function are included in the damping layer such that the damping layer has detachability against the base, the diaphragm 1 according to the present invention has comparatively great internal loss (loss tangent) and comparatively small Young's modulus (storage elastic modulus).

Hereinafter described is what is considered to be the cause to make Young's modulus comparatively small and internal loss comparatively great.

In the diaphragm 1, the base and the damping layer are in contact with each other. If the damping layer does not has particles having a heat dissipating function, since most of the interface between the base and the damping layer is a valid adhesive area, adhesive strength between the base and the damping layer is comparatively great strength such that the base and the damping layer are integrated.

On the contrary, if the damping layer includes particles having a heat dissipating function, a valid adhesive area in the interface between the base and the damping layer is reduced to weaken adhesion between the damping layer and the base due to existence of particles having a heat dissipating function (adhesive strength between particles having a heat dissipating function and the base is comparatively smaller than adhesive force between a resin configuring the damping layer and the base), and thus detachability is generated between the base and the damping layer. Further, it can be estimated that particles having a heat dissipating function exist in the interface between the base and the damping layer or a density of particles having a heat dissipating function is comparatively great on the base side in the damping layer. As such, it can be considered that the valid adhesive area in the interface between the base and the damping layer is reduced to weaken adhesion between the damping layer and the base, and thus detachability is generated between the base and the damping layer.

It can be estimated that this detachability may cause a slide in the interface when an external force or a vibration is applied to the diaphragm 1 and Young's modulus becomes comparatively small. Further, it can be considered that when vibration is transmitted to the diaphragm (when the diaphragm is bent), unwanted vibration is absorbed or subdued (offset) by the slide between the base and the damping layer, and thus internal loss becomes comparatively great.

The present invention is not limited to the above-mentioned embodiments. For example, the shape of the diaphragm, the edge, the voice coil, the magnetic circuit, the acoustic converter, etc. may be of any shape.

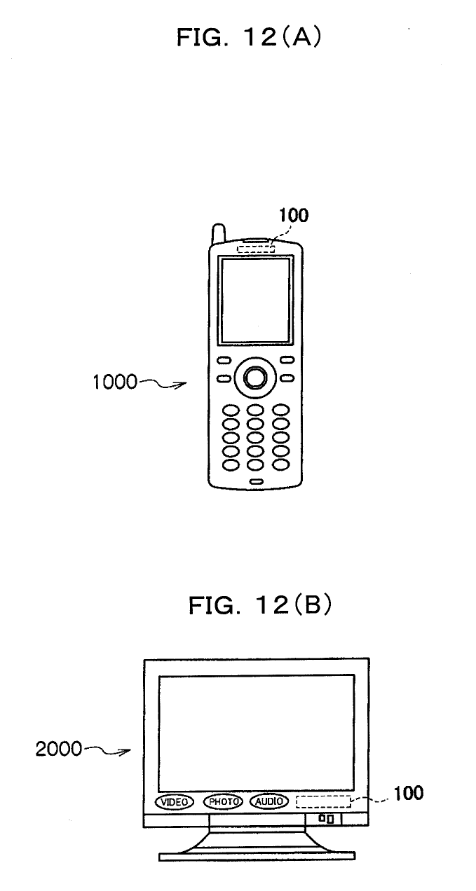

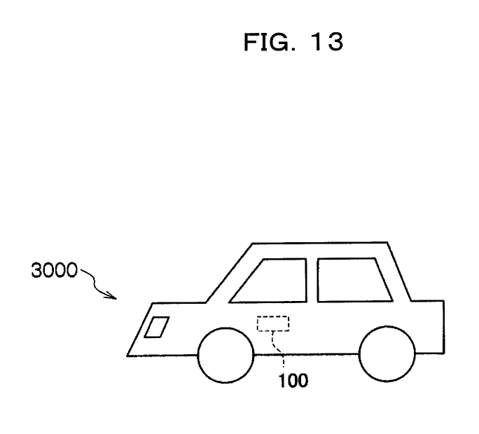

As the diaphragm for acoustic converter according to an embodiment of the present invention has comparatively high thermolytic action, it may be effectively used in a vehicle interior or in an electronic device to high temperature. FIG. 12 is a view that illustrates electronic devices 1000 and 2000 including an acoustic converter 100 according to an embodiment of the present invention (for example, FIG. 12 (A) shows a handheld terminal and FIG. 12(B) shows a flat panel display). FIG. 13 is a view that illustrates an automobile 3000 including an acoustic converter 100 according to an embodiment of the present invention.

1. A diaphragm for acoustic converter comprising:
a base; and
a damping layer formed on one surface or both surfaces of the base,
wherein
said damping layer includes a particle having a heat dissipating function, and
said damping layer has detachability with respect to said base.

2. The diaphragm for acoustic converter according to claim 1, wherein the diaphragm for acoustic converter has a greater loss tangent than the loss tangent of said base of the diaphragm for acoustic converter.

3. The diaphragm for acoustic converter according to claim 2, wherein the diaphragm for acoustic converter has a smaller storage elastic modulus than the storage elastic modulus of said base of the diaphragm for acoustic converter.

4. The diaphragm for acoustic converter according to claim 3, wherein
said damping layer further includes a particle having a charge restraining function, and
the particle having said heat dissipating function is a particle that is different from the particle having said charge restraining function.

5. The diaphragm for acoustic converter according to claim 4, wherein at least one resin material configuring said damping layer has a peak temperature of the loss tangent that is around 0° C. or higher.

6. The diaphragm for acoustic converter according to claim 5, wherein a resin material different from said one resin material configuring said damping layer has a peak temperature of the loss tangent higher than said one resin material and lower than said base.

7. The diaphragm for acoustic converter according to claim 5, wherein a resin material different from said one resin material configuring said damping layer has a peak temperature of the loss tangent higher than said one resin material and said base.

8. The diaphragm for acoustic converter according to claim 6, wherein said damping layer and said base are films.

9. The diaphragm for acoustic converter according to claim 2, wherein said storage elastic modulus is a characteristic value near a lowest resonance frequency.

10. The diaphragm for acoustic converter according to claim 1, wherein
said base includes an aromatic-system resin material, and
said damping layer further includes an aliphatic-system resin.

11. The diaphragm for acoustic converter according to claim 1, wherein said base includes a polysulfone resin.

12. The diaphragm for acoustic converter according to claim 1, wherein said base includes a thermoplastic resin including an aromatic nucleous bond, a sulfone bond, an ether bond or a phenyl bond as structure unit.

13. The diaphragm for acoustic converter according to claim 1, wherein said damping layer is configured with a plurality of cover layers sandwiching an inner layer.

14. The diaphragm for acoustic converter according to claim 1, wherein
said damping layer has a laminate structure including a plurality of layers that are laminated, and
in the plurality of layers of said damping layer, a density of particles having a heat dissipating function is smaller in a layer formed on the side of the base than in a layer formed on the side of the magnetic circuit.

15. The diaphragm for acoustic converter according to claim 1, wherein said damping layer includes a polyurethane-system resin, an epoxy-system resin, a mixture of a polypropylene-system resin and a styrene-system resin, a polyester-system resin, a polyether-system resin, a silicon-system resin, a polyamide-system resin, a copolymer of ethylene-vinyl acetate rubber, or a polymethacrylate-system resin.

16. The diaphragm for acoustic converter according to claim 1, wherein the particle having said heat dissipating function includes mica or silicon oxide.

17. The diaphragm for acoustic converter according to claim 1, further comprising a vibrating part and an edge, wherein
the radially cross-sectional shape of said edge is formed in a concave shape or a convex shape.

18. The diaphragm for acoustic converter according to claim 5, wherein the particles having said charge restraining function are tin oxide.

19. The diaphragm for acoustic converter according to claim 1, wherein a peak temperature of the loss tangent of said damping layer is lower than a peak temperature of the loss tangent of said base.

20. The diaphragm for acoustic converter according to claim 1, wherein
said diaphragm for acoustic converter has a greater loss tangent than polyetherimide film that has substantially the same thickness as said diaphragm for acoustic converter at room temperature of 20° C., and
said diaphragm for acoustic converter has a smaller storage elastic modulus than polyethylene naphthalate that has substantially the same thickness as said diaphragm for acoustic converter in a resonance frequency at room temperature of 20° C.

21. The diaphragm for acoustic converter according to claim 1, wherein said base includes a polyester-system elastomer.

22. An acoustic converter comprising:
said diaphragm for acoustic converter according to claim 1,
a vibrating body including a voice coil supported by the diaphragm for acoustic converter, a frame vibratably supporting said vibrating body, and a magnetic circuit forming a magnetic gap in which said voice coil is arranged.

23. The acoustic converter according to claim 22, wherein
said damping layer including at least a particle having a heat dissipating function is formed closer to said magnetic circuit than said base of said diaphragm for acoustic converter.

24. An electronic device comprising the acoustic converter according to claim 22.

25. An automobile comprising the acoustic converter according to claim 22.
